(19) United States
(12) Patent Application Publication
(10) Pub. No.: US 2012/0319577 A1
(43) Pub. Date: Dec. 20, 2012

(54) PLASMA DISPLAY PANEL

(76) Inventors: Masanori Miura, Osaka (JP); Takuji Tsujita, Osaka (JP); Masashi Gotou, Osaka (JP)

(21) Appl. No.: 13/581,781

(22) PCT Filed: Mar. 10, 2011
(86) PCT No.: PCT/JP2011/001392

§ 371 Date: Aug. 29, 2012

(30) Foreign Application Priority Data
Mar. 17, 2010 (JP) 2010-060591
Mar. 26, 2010 (JP) 2010-071983

(51) Int. Cl. H01J 17/49

(52) U.S. Cl. 313/587

(57) ABSTRACT

A plasma display has a protective layer (9) including a base layer (91) over which aggregate particles (92) each including an aggregate of a plurality of magnesium oxide crystal particles (92a) and metal oxide particles (93) are scattered. The metal oxide particles (93) contain at least two metal oxides selected from the group consisting of magnesium oxide, calcium oxide, strontium oxide, and barium oxide. X-ray diffraction analysis of the metal oxide particles (93) shows a diffraction peak of a specific crystal plane between a diffraction peak of the specific crystal plane of one of the two metal oxides and a diffraction peak of the specific crystal plane of another one of the two metal oxides.

### TECHNICAL FIELD

The present invention relates to plasma display panels for use in display devices, etc.

BACKGROUND ART

Plasma display panels (hereinafter referred to as “PDPs”), which can have a high-definition and large screen, have been commercialized as 100-inch class televisions, etc. In recent years, PDPs have found application in high-definition television systems in which the number of scanning lines is twice or more than that of the conventional NTSC system, and there also has been an increasing demand for a lead-free PDP in view of environmental problems and measures to further reduce power consumption in response to energy problems.

The PDP basically includes a front plate and a rear plate. The front plate includes a glass substrate that is formed of sodium borosilicate-based glass by float glass process, display electrodes each composed of stripe-shaped transparent and bus electrodes, which are formed on one main surface of the glass substrate, a dielectric layer that is placed over the display electrodes to serve as a capacitor, and a protective layer that is formed of magnesium oxide (MgO) on the dielectric layer.

On the other hand, the rear plate includes a glass substrate, stripe-shaped address electrodes formed on one main surface of the glass substrate, an insulating layer placed over the address electrodes, barrier ribs formed on the insulating layer, and phosphor layers that are each formed between the barrier ribs, and emit red light, green light, and blue light, respectively.

The front and rear plates are arranged with their electrode-forming sides facing each other and sealed hermetically, and neon (Ne)-xenon (Xe) discharge gas is sealed at a pressure between 400 Torr and 600 Torr (5.3×104 Pa and 8.0×104 Pa) in the discharge space partitioned by the barrier ribs. In the PDP, an image signal voltage is selectively applied to the display electrodes to generate discharge, and ultraviolet light generated by the discharge excite the phosphor layers of each color, so that color image display is achieved by the emission of red light, green light, and blue light.

A method generally used for driving such a PDP includes: an initialization period in which wall charges are controlled so that writing can be readily performed; a writing period in which writing discharge is generated in response to an input image signal; and a sustain period in which sustain discharge is generated in the discharge space, where the writing has been performed, so that display is performed. These periods are combined to form a certain period (subfield), which is repeated a plurality of times in a period (one field) corresponding to one image frame, so that the PDP achieves gradation display.

In such a PDP, the role of the protective layer formed on the dielectric layer of the front plate includes protecting the dielectric layer from discharge-induced ion impact, emitting initial electrons for generating address discharge, and others. The protection of the dielectric layer from ion impact is an important role to prevent an increase in discharge voltage, and the emission of initial electrons for generating address discharge is an important role to prevent address discharge failure, which can cause image flicker.

There is disclosed a technique for increasing the number of initial electrons emitted from a productive layer so that image flicker can be reduced, examples of which include doping a magnesium oxide (MgO) protective layer with an impurity and forming magnesium oxide (MgO) particles on a magnesium oxide (MgO) protective layer (see for example PTL 1, 2, 3, 4, and 5).

In recent years, high-definition televisions have become more popular, and the market requires low-cost, low-power-consumption, high-brightness PDPs of full-HD (high-definition) (1,920×1,080 pixels, progressive display). Since the characteristic of emitting electrons from a protective layer determines PDP image quality, it is very important to control electron emission characteristics.

Specifically, although one-field time is constant, the number of writing pixels should be increased so that high-definition images can be displayed, which creates a need to narrow the width of a pulse applied to address electrodes during the writing period in the subfield. Unfortunately, a time lag called “discharge delay” occurs between the voltage pulse rise and the generation of discharge in the discharge space, and therefore, as the pulse width decreases, the possibility of completing discharge within the writing period decreases. This can cause lighting failure and the problem of a reduction in image quality, such as flicker.

In order to increase the efficiency of discharge-induced emission so that power consumption can be reduced, the content of xenon (Xe), a component of discharge gas contributing to phosphor emission, in the whole of discharge gas can be increased. In this case, discharge voltage increases, and discharge delay also increases, so that the problem of a reduction in image quality, such as lighting failure also occurs.

Therefore, in making high-definition, low-power-consumption PDPs, there has been a challenge to achieve both prevention of an increase in discharge voltage and lighting failure reduction to improve image quality.

There have been attempts to dope a protective layer with an impurity so that electron emission characteristics can be improved. Unfortunately, when a protective layer is doped with an impurity so that electron emission characteristics can be improved, charges decrease with time at a higher attenuation rate in the process of storing charges on the surface of a protective layer for use as a memory function part. Therefore, a measure to reduce this problem, such as an increase in applied voltage, is necessary.

On the other hand, in the case where magnesium oxide (MgO) crystal particles are formed on a magnesium oxide (MgO) protective layer, discharge delay can be reduced so that lighting failure can be reduced, but there is a problem in which discharge voltage cannot be reduced.

### CITATION LIST

### Patent Literatures

PTL 1: Unexamined Japanese Patent Publication No. 2002-260535
PTL 2: Unexamined Japanese Patent Publication No. H11-339665
PTL 3: Unexamined Japanese Patent Publication No. 2006-59779
PTL 4: Unexamined Japanese Patent Publication No. H08-236028
PTL 5: Unexamined Japanese Patent Publication No. H10-334809

### SUMMARY OF THE INVENTION

The invention is directed to a PDP including a front plate and a rear plate opposed to the front plate, wherein the front plate has a dielectric layer and a protective layer placed over the dielectric layer, the rear plate has an insulating layer, a plurality of barrier ribs formed on the insulating layer, and phosphor layers formed on the insulating layer and sides of the barrier ribs, the protective layer includes a base layer formed on the dielectric layer, the protective layer further includes: aggregate particles each including an aggregate of a plurality of magnesium oxide crystal particles; and metal oxide particles, wherein the aggregate particles and the metal oxide particles are scattered and deposited over the base layer, the metal oxide particles contain at least two metal oxides selected from the group consisting of magnesium oxide, calcium oxide, strontium oxide, and barium oxide, and X-ray diffraction analysis of the metal oxide particles shows a diffraction peak of a specific crystal plane between a diffraction peak of the specific crystal plane of one of the two metal oxides and a diffraction peak of the specific crystal plane of another one of the two metal oxides.

According to this feature, the protective layer can have improved secondary electron emission characteristics, which makes it possible to reduce discharge starting voltage even when the partial pressure of xenon (Xe) in discharge gas is increased to increase brightness, and also makes it possible to provide a high display performance PDP that is reduced in discharge delay and prevented from causing lighting failure even when displaying high-definition images and to provide a PDP that can be driven with high brightness at low voltage even when displaying high-definition images.

### BRIEF DESCRIPTION OF DRAWINGS

FIG. 1 is a perspective view showing the structure of a PDP according to an embodiment of the present invention;

FIG. 2 is a cross-sectional view showing the structure of the front plate of the PDP;

FIG. 3 is a chart showing the results of X-ray diffraction of the base layer of the PDP;

FIG. 4 is a chart showing the results of X-ray diffraction of the base layer of the PDP having another structure;

FIG. 5 is an enlarged diagram for illustrating an aggregate particle in the PDP;

FIG. 6 is a graph showing the relationship between the concentration of calcium (Ca) in a protective layer and discharge delay in the PDP;

FIG. 7 is a graph showing the results of the examination of the electron emission performance and the lighting voltage of the PDP;

FIG. 8 is a characteristic diagram showing the relationship between the electron emission performance and the particle diameter of the crystal particles used in the PDP; and

FIG. 9 is a graph showing the results of the examination of the electron emission performance and the lighting voltage of the PDP.

### DESCRIPTION OF EMBODIMENTS

Hereinafter, a PDP according to an embodiment of the present invention is described with reference to the drawings.

### First Exemplary Embodiment

Hereinafter, a description is given of a PDP according to a first exemplary embodiment of the present invention.

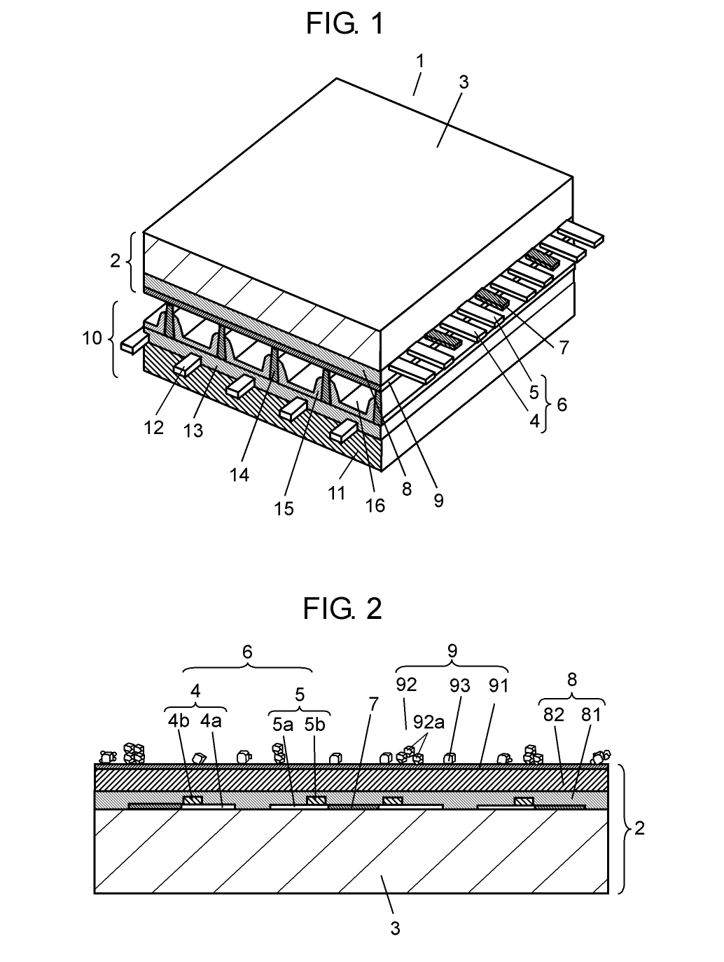

FIG. 1 is a perspective view showing the structure of a PDP according to an embodiment of the present invention. PDP 1 has the same basic structure as that of a general AC surface-discharge PDP. As shown in FIG. 1, PDP 1 includes: front plate 2 including front glass substrate 3 and other components; rear plate 10 including rear glass substrate 11 and other components, which is opposed to front plate 2; and a sealing material made of a glass frit or the like, with which the periphery thereof is hermetically sealed. Discharge gas such as xenon (Xe) and neon (Ne) is sealed at a pressure between 400 Torr and 600 Torr (5.3×10⁴ Pa and 8.0×10⁴ Pa) in discharge space 16 inside sealed PDP 1.

In front plate 2, strip-shaped display electrodes 6 each including a set of scan electrode 4 and sustain electrode 5 and black stripes (light-shielding layers) 7 are arranged in a plurality of parallel rows on front glass substrate 3. Dielectric layer 8, which is placed over display electrodes 6 and light-shielding layers 7 and holds electric charges to serve as a capacitor, is formed on front glass substrate 3, and protective layer 9 is further formed thereon.

In rear plate 10, a plurality of strip-shaped address electrodes 12 are arranged on rear glass substrate 11 parallel to one another in a direction perpendicular to scan and sustain electrodes 4 and 5 of front plate 2, and address electrodes 12 are covered with insulating layer 13. Barrier ribs 14 with a predetermined height are each formed on part of insulating layer 13 between address electrodes 12 to divide discharge space 16. Each groove between barrier ribs 14 has each of phosphor layers 15 for emitting red light, green light, and blue light, respectively, when irradiated with ultraviolet light, which are formed in order by coating. Discharge spaces are formed at the intersections of scan and sustain electrodes 4 and 5 and address electrodes 12. The discharge spaces having phosphor layers 15 for red, green, and blue colors arranged in the direction of display electrode 6 form pixels for color display.

FIG. 2 is a cross-sectional view showing the structure of front plate 2 of PDP 1 according to this embodiment. The structure in FIG. 1 is shown upside down in FIG. 2. As shown in FIG. 2, display electrodes 6 each including scan and sustain electrodes 5 and light-shielding layers 7 are formed in patterns on front glass substrate 3 produced by float glass process or the like. Scan and sustain electrodes 4 and 5 each include transparent electrode 4a or 5a made of indium tin oxide (ITO), tin oxide (SnO₂) or the like, and metal bus electrode 4b or 5b formed on transparent electrode 4a or 5a. Metal bus electrode 4b or 5b is used to provide electrical conductivity in the longitudinal direction of transparent electrode 4a or 5a and made of a silver (Ag) material-based, electrically-conductive material.

Dielectric layer 8 has an at least two-layer structure including: first dielectric layer 81 provided over all of transparent electrodes 4a and 5a, metal bus electrodes 4b and 5b, and light-shielding layers 7 formed on front glass substrate 3; and second dielectric layer 82 formed on first dielectric layer 81. Protective layer 9 is further formed on second dielectric layer 82.

Protective layer 9 includes: base layer 91 formed of magnesium oxide on dielectric layer 8; aggregate particles 92 each including a plurality of magnesium oxide (MgO) crystal particles 92a aggregated on base layer 91; and metal oxide particles 93 made of at least two oxides selected from magnesium oxide (MgO), calcium oxide (CaO), strontium oxide (SrO), and barium oxide (BaO), which are deposited on base layer 91.

Next, a description is given of a method for manufacturing such PDP 1. First, scan and sustain electrodes 4 and 5 and light-shielding layers 7 are formed on front glass substrate 3. Transparent electrodes 4a and 5a and metal bus electrodes 4b and 5b, which form scan and sustain electrodes 4 and 5 respectively, are patterned using photolithography or the like. Transparent electrodes 4a and 5a are formed using a thin film-forming process or the like, and metal bus electrodes 4b and 5b are each formed by firing a silver (Ag) material-containing paste at a predetermined temperature into a solid. Similarly, light-shielding layers 7 are formed by a process including applying a black pigment-containing paste by a screen printing method or applying a black pigment over the surface of the glass substrate, which is followed by patterning using photolithography, and performing firing.

Subsequently, a dielectric paste (dielectric material) is applied over scan and sustain electrodes 4 and 5 and light-shielding layers 7 on front glass substrate 3 by a die coating method or the like to form a dielectric paste (dielectric material) layer. The applied dielectric paste is then allowed to stand for a predetermined period of time so that its surface is leveled to form a flat surface. The dielectric paste layer is then solidified by firing so that dielectric layer 8 is formed over scan and sustain electrodes 4 and 5 and light-shielding layers 7. The dielectric paste is a coating composition containing a dielectric material such as a glass powder, a binder, and a solvent.

Subsequently, base layer 91 is formed on dielectric layer 8.

Base layer 91 is formed by a thin film-forming method using magnesium oxide (MgO) pellets. A known method such as electron beam evaporation, sputtering, or ion plating may be used as the thin film-forming method. For example, 1 Pa or 0.1 Pa is considered to be an upper limit of the pressure that can be practically used in a sputtering method or an electron beam evaporation method as an example of the evaporation method.

The atmosphere in which base layer 91 is formed may be controlled in an enclosed state insulated from the outside so that water deposition or impurity adsorption can be prevented, which makes it possible to form base layer 91 of a metal oxide with the desired electron emission characteristics.

Next, a description is given of aggregate particles 92 of magnesium oxide (MgO) crystal particles 92a formed and deposited on base layer 91. These crystal particles 92a may be produced by any one of the vapor-phase synthesis method or the precursor firing method described below.

The vapor-phase synthesis method includes heating a magnesium metal material with a purity of 99.9% or more in an atmosphere filled with inert gas and introducing a small amount of oxygen into the atmosphere to oxidize magnesium directly, so that magnesium oxide (MgO) crystal particles 92a are produced.

On the other hand, the precursor firing method can produce crystal particles 92a by using the process described below. The precursor firing method includes uniformly firing a magnesium oxide (MgO) precursor at a high temperature of 700° C. or more and gradually cooling the product to form magnesium oxide (MgO) crystal particles 92a. For example, the precursor may be at least one compound selected from magnesium alkoxide (Mg(OR)₂), acetylacetone magnesium (Mg(acac)₂), magnesium hydroxide (Mg(OH)₂), magnesium carbonate (MgCO₂), magnesium chloride (MgCl₂), magnesium sulfate (MgSO₄), magnesium nitrate (Mg(NO₃)₂), and magnesium oxalate (MgC₂O₄). In some cases, the selected compound can usually exists in the form of a hydrate, and such a hydrate may also be used.

These compounds should be so controlled that magnesium oxide (MgO) with a purity of 99.95% or more, preferably 99.98% or more can be obtained after the firing. This is because if these compounds contain a certain amount or more of an impurity element such as any alkali metal, B, Si, Fe, or Al, unnecessary particle-particle fusion or sintering can occur during the heat treatment so that it can be difficult to obtain highly crystalline magnesium oxide (MgO) particles 92a. Therefore, it is necessary to previously control the precursor by removal of impurity elements or the like.

Next, a description is given of metal oxide particles 93, formed and deposited on base layer 91, made of at least two oxides selected from magnesium oxide (MgO), calcium oxide (CaO), strontium oxide (SrO), and barium oxide (BaO). For example, metal oxide particles 93 can be obtained by a vapor-phase synthesis method. In an atmosphere filled with inert gas, two or more metal materials selected from magnesium (Mg), calcium (Ca), strontium (Sr), and barium (Ba) are simultaneously heated and sublimed to form a high-temperature gas region. When oxygen gas is introduced so that the high-temperature gas region can be enveloped in the oxygen gas, instantaneous cooling occurs at the interface between the high-temperature gas region and the introduced oxygen gas region, so that metal oxide particles 93 can be produced.

Magnesium oxide (MgO) crystal particles 92a obtained by any one of the above methods and metal oxide particles 93 are dispersed in a solvent, and the resulting dispersion is scattered on the surface of base layer 91 by a spray method, a screen-printing method, an electrostatic coating method, or the like. Drying and firing processes are then performed to remove the solvent so that magnesium oxide (MgO) crystal particles 92a and metal oxide particles 93 can be fixed on the surface of base layer 91. Methods for dispersing magnesium oxide (MgO) crystal particles 92a and metal oxide particles 93 include a method including dispersing them in the same solvent and applying them simultaneously and a method including preparing different dispersions and applying them sequentially. Any one of these methods may be used for the application.

When such a series of processes are performed, the desired components (scan electrodes 4, sustain electrodes 5, light-shielding layers 7, dielectric layer 8, and protective layer 9) are formed so that front plate 2 is completed.

On the other hand, rear plate 10 is formed as described below. First, material layers for forming address electrodes 12 are formed on rear glass substrate 11 by a method of screen-printing a silver (Ag) material-containing paste, a method including forming a metal film over the surface and then patterning the film using photolithography, or other methods. Firing at a predetermined temperature is then performed to form address electrodes 12. Subsequently, a dielectric paste is applied by a die coating method or the like over address electrodes 12 formed on rear glass substrate 11, so that a dielectric paste layer is formed. The dielectric paste layer is then fired to form insulating layer 13. The dielectric paste is a coating composition containing a dielectric material such as a glass powder, a binder, and a solvent.

Subsequently, a barrier rib-forming paste containing a barrier rib material is applied to insulating layer 13 and dried. A bonding layer-forming paste containing a bonding layer material is then applied to the dried barrier rib-forming paste, and they are patterned into predetermined shapes, so that barrier rib material layers and bonding material layers are formed. Firing at a predetermined temperature is then performed to form barrier ribs 14 and bonding layers. In this process, the barrier rib-forming paste applied to insulating layer 13 and the bonding layer-forming paste may be patterned using a photolithographic method or a sand blasting method. Subsequently, each phosphor paste containing a phosphor is applied to part of insulating layer 13 between adjacent barrier ribs 14 and to the side surfaces of barrier ribs 14, and fired, so that each phosphor layer 15 is formed. A glass frit for strongly bonding front plate 2 and rear plate 10 together is formed around rear plate 10. After the above processes, rear plate 10 is completed, having desired components formed on rear glass substrate 11.

Subsequently, front plate 2 and rear plate 10, each having desired components, are arranged parallel and fixed so that scan electrodes 4 are perpendicular to address electrodes 12. The fixed front and rear plates 2 and 10 are fired at a temperature not lower than the melting points of the glass frit and the bonding material layer and not higher than the melting point of the barrier rib material layer. This process bonds front and rear plates 2 and 10 together with the bonding layer and the glass frit. Finally, discharge gas containing xenon (Xe) and neon (Ne) etc. is sealed in discharge spaces 16, so that PDP 1 is completed.

First and second dielectric layers 81 and 82, which form dielectric layer 8 of front plate 2, are then described in detail. The dielectric material for first dielectric layer 81 has the material composition described below. Specifically, the dielectric material contains 20 wt % to 40 wt % of bismuth oxide (Bi₂O₃), 0.5 wt % to 12 wt % of at least one selected from calcium oxide (CaO), strontium oxide (SrO), and barium oxide (BaO), and 0.1 wt % to 7 wt % of at least one selected from molybdenum oxide (MoO₃), tungsten oxide (WO₃), cerium oxide (CeO₂), and manganese oxide (MnO₂).

In place of molybdenum oxide (MoO₃), tungsten oxide (WO₃), cerium oxide (CeO₂), or manganese oxide (MnO₂), the electric material may contain 0.1 wt % to 7 wt % of at least one selected from copper oxide (CuO), chromium oxide (Cr₂O₃), cobalt oxide (Co₂O₃), vanadium oxide (V₂O₇), and antimony oxide (Sb₂O₃).

Besides the above components, the dielectric material may also contain a lead-free material component such as 0 wt % to 40 wt % of zinc oxide (ZnO), 0 wt % to 35 wt % of boron oxide (B₂O₃), 0 wt % to 15 wt % of silicon oxide (SiO₂), or 0 wt % to 10 wt % of aluminum oxide (Al₂O₃).

Using a wet-type jet mill or a ball mill, the dielectric material containing these components is ground into a particle diameter between 0.5 μm and 2.5 μm to form a dielectric material powder. Subsequently, 55 wt % to 70 wt % of the dielectric material powder and 30 wt % to 45 wt % of a binder component are sufficiently kneaded using a three-roll mill to form a paste for first dielectric layer 81, which is to be used in die coating or printing.

The binder component is a terpineol or butyl carbitol acetate composition containing 1 wt % to 20 wt % of ethyl cellulose or acrylic resin. If necessary, the paste may also contain a plasticizer such as dioctyl phthalate, dibutyl phthalate, triphenyl phosphate, or tributyl phosphate and a dispersing agent such as glycerol monooleate, sorbitan sesquioleate, Homogenol (product name of Kao Corporation), or an alkylallyl phosphate so that the paste can have improved printing properties.

Subsequently, the first dielectric layer-forming paste is used and printed on front glass substrate 3 by a die coating or screen-printing method so as to cover display electrodes 6, and dried, which is followed by firing at a temperature between 575° C. and 590° C. slightly higher than the softening point of the dielectric material, so that first dielectric layer 81 is formed.

Next, a description is given of second dielectric layer 82. The dielectric material for second dielectric layer 82 has the material composition described below. Specifically, the dielectric material contains 11 wt % to 20 wt % of bismuth oxide (Bi₂O₃), 1.6 wt % to 21 wt % of at least one selected from calcium oxide (CaO), strontium oxide (SrO), and barium oxide (BaO), and 0.1 wt % to 7 wt % of at least one selected from molybdenum oxide (MoO₃), tungsten oxide (WO₃), and cerium oxide (CeO₂). In place of molybdenum oxide (MoO₃), tungsten oxide (WO₃), or cerium oxide (CeO₂), the dielectric material may contain 0.1 wt % to 7 wt % of at least one selected from copper oxide (CuO), chromium oxide (Cr₂O₃), cobalt oxide (Co₂O₃), vanadium oxide (V₂O₇), antimony oxide (Sb₂O₃), and manganese oxide (MnO₂).

Besides the above components, the dielectric material may also contain a lead-free material component such as 0 wt % to 40 wt % of zinc oxide (ZnO), 0 wt % to 35 wt % of boron oxide (B₂O₃), 0 wt % to 15 wt % of silicon oxide (SiO₂), or 0 wt % to 10 wt % of aluminum oxide (Al₂O₃).

Using a wet-type jet mill or a ball mill, the dielectric material containing these components is ground into a particle diameter between 0.5 μm and 2.5 μm to form a dielectric material powder. Subsequently, 55 wt % to 70 wt % of the dielectric material powder and 30 wt % to 45 wt % of a binder component are sufficiently kneaded using a three-roll mill to form a paste for the second dielectric layer, which is to be used in die coating or printing. The binder component is a terpineol or butyl carbitol acetate composition containing 1 wt % to 20 wt % of ethyl cellulose or acrylic resin. If necessary, the paste may also contain a plasticizer such as dioctyl phthalate, dibutyl phthalate, triphenyl phosphate, or tributyl phosphate and a dispersing agent such as glycerol monooleate, sorbitan sesquioleate, Homogenol (product name of Kao Corporation), or an alkylallyl phosphate so that the paste can have improved printing properties.

Subsequently, the second dielectric layer-forming paste is used and printed on first dielectric layer 81 by a screen-printing or die coating method, and dried, which is followed by firing at a temperature between 550° C. and 590° C. slightly higher than the softening point of the dielectric material.

Concerning the thickness of dielectric layer 8, the total thickness of first and second dielectric layers 81 and 82 is preferably 41 μm or less so that a certain visible-light transmittance can be ensured. To suppress the reaction of metal bus electrodes 4b and 5b with silver (Ag), the bismuth oxide (Bi₂O₃) content of first dielectric layer 81 is set at 20 wt % to 40 wt %, which is higher than the bismuth oxide (Bi₂O₃) content of second dielectric layer 82. Therefore, since the visible light transmittance of first dielectric layer 81 is lower than that of second dielectric layer 82, the thickness of first dielectric layer 81 is made thinner than that of second dielectric layer 82.

If second dielectric layer 82 has a bismuth oxide (Bi₂O₃) content of 11 wt % or less, bubbles will tend to be generated in second dielectric layer 82, which is not preferred, although coloring will be less likely to occur. On the other hand, if the content is more than 40 wt %, coloring will be more likely to occur so that the transmittance can decrease.

As the thickness of dielectric layer 8 decreases, the effect of increasing brightness and reducing discharge voltage becomes more significant. Therefore, the thickness of dielectric layer 8 is preferably set as small as possible, as long as the withstand voltage does not decrease. From such a point of view, the thicknesses of dielectric layer 8, first dielectric layer 81, and second dielectric layer 82 are set at 41 μm or less, from 5 μm to 15 μm, and from 20 μm to 36 μm, respectively, in this embodiment.

Next, a description is given of the bonding layer-forming material. The bonding layer-forming material is preferably a low-melting-point material such as frit glass or water glass with a melting point lower than that of barrier rib 14 made of a material with a melting point between 500° C. and 600° C. An ultraviolet adhesive with low hygroscopicity and less outgas or a sealing agent generally used in vacuum devices may also be used.

It has been demonstrated that even when display electrodes 6 are formed using a silver (Ag) material, PDP 1 manufactured as described above is less likely to cause a front glass substrate 3-coloring phenomenon (yellowing) and prevented from generating bubbles in dielectric layer 8 and successfully has dielectric layer 8 with high withstand voltage performance.

Next, a discussion is given about why the use of these dielectric materials in first dielectric layer 81 can suppress yellowing and bubble generation in PDP 1 according to this embodiment. It is known that when molybdenum oxide (MoO₃) or tungsten oxide (WO₃) is added to bismuth oxide (Bi₂O₃)-containing dielectric glass, such a compound as Ag₂MoO₄, Ag₂Mo₂O₇, Ag₂Mo₄O₁₃, Ag₂WO₄, Ag₂W₂O₇, or Ag₂W₄O₁₃ is easily produced at a low temperature of 580° C. or less. In this embodiment, since the firing temperature for dielectric layer 8 is from 550° C. to 590° C., silver ions (Ag⁺) diffusing in dielectric layer 8 during the firing are allowed to react with molybdenum oxide (MoO₃), tungsten oxide (WO₃), cerium oxide (CeO₂), or manganese oxide (MnO₂) in dielectric layer 8, and stabilized by forming a stable compound. In other words, silver ions (Ag⁺) are stabilized without undergoing reduction, so that they do not aggregate to form a colloid. Therefore, the stabilization of silver ions (Ag⁺) reduces the production of oxygen associated with silver (Ag) colloid formation, so that the generation of bubbles in dielectric layer 8 is also reduced.

On the other hand, to make these effects more advantageous, the content of molybdenum oxide (MoO₃), tungsten oxide (WO₃), cerium oxide (CeO₂), or manganese oxide (MnO₂) in the bismuth oxide (Bi₂O₃)-containing dielectric glass is preferably set at 0.1 wt % or more, more preferably set at between 0.1 wt % and 7 wt %. In particular, if the content is less than 0.1 wt %, the effect of suppressing yellowing can be reduced, and if the content is more than 7 wt %, yellowing of the glass can occur, which is not preferred.

In dielectric layer 8 of PDP 1 according to this embodiment, first dielectric layer 81 in contact with metal bus electrodes 4b and 5b made of a silver (Ag) material suppresses the yellowing phenomenon and the bubble generation, and second dielectric layer 82 provided on first dielectric layer 81 achieves high light-transmittance. As a result, the whole of dielectric layer 8 makes it possible to form a high-transmittance PDP in which bubbles and yellowing are very less likely to occur.

Next, a detailed description is given of protective layer 9 in this embodiment.

As shown in FIG. 2, the PDP according to this embodiment has protective layer 9 that includes: base layer 91 formed of magnesium oxide (MgO) on dielectric layer 8; aggregate particles 92 each including a plurality of magnesium oxide (MgO) crystal particles 92a aggregated and deposited on base layer 91; and metal oxide particles 93 deposited on base layer 91. Metal oxide particles 93 are made of metal oxides including at least two oxides selected from magnesium oxide (MgO), calcium oxide (CaO), strontium oxide (SrO), and barium oxide (BaO), and X-ray diffraction analysis of the metal oxides shows a peak of a specific crystal plane at a diffraction angle between the minimum and maximum diffraction angles each occurring for one oxide as a component of the metal oxides. Specifically, X-ray diffraction analysis of metal oxide particles 93 containing at least two metal oxides shows a diffraction peak of a specific crystal plane between a diffraction peak of the specific crystal plane of one of the two metal oxides and a diffraction peak of the specific crystal plane of another one of the two metal oxides.

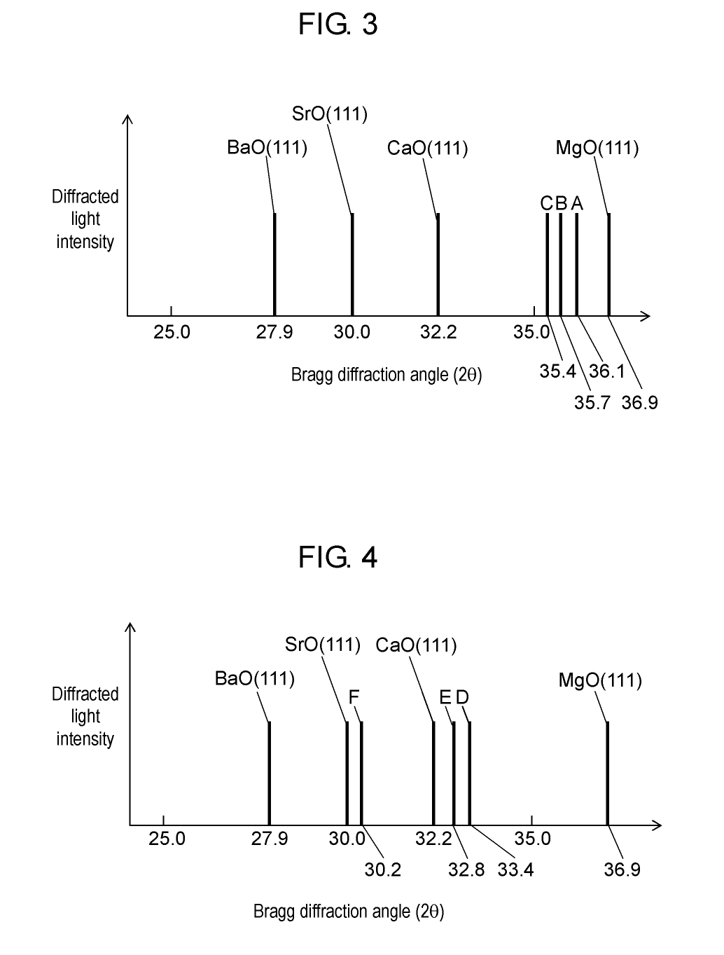

FIG. 3 is a chart showing the results of X-ray diffraction of the surface of base layer 91 that forms protective layer 9 of PDP 1 according to this embodiment. FIG. 3 also shows the results of X-ray diffraction analysis of magnesium oxide (MgO) alone, calcium oxide (CaO) alone, strontium oxide (SrO) alone, and barium oxide (BaO) alone.

In FIG. 3, the horizontal axis represents the Bragg's diffraction angle (2θ), and the vertical axis represents the X-ray diffraction wave intensity. The diffraction angle is expressed in units of degrees, wherein 360 degrees correspond to a full circle, and the intensity is expressed in arbitrary units. In FIG. 3, the crystal plane indicating a specific crystal orientation is parenthesized. FIG. 3 shows that for the (111) crystal plane, calcium oxide (CaO) alone has a peak at a diffraction angle of 32.2 degrees, magnesium oxide (MgO) alone at a diffraction angle of 36.9 degrees, strontium oxide alone at a diffraction angle of 30.0 degrees, and barium oxide alone at a diffraction angle of 27.9 degrees.

In PDP 1 according to this embodiment, metal oxide particles 93 in protective layer 9 are made of metal oxides including at least two oxides selected from magnesium oxide (MgO), calcium oxide (CaO), strontium oxide (SrO), and barium oxide (BaO).

FIG. 3 shows the results of X-ray diffraction in cases where metal oxide particles 93 are composed of two simple oxides. Specifically, point A indicates the result of X-ray diffraction of metal oxide particles 93 formed using magnesium oxide (MgO) and calcium oxide (CaO), point B indicates the result of X-ray diffraction of metal oxide particles 93 formed using magnesium oxide (MgO) and strontium oxide (SrO), and point C indicates the result of X-ray diffraction of metal oxide particles 93 formed using magnesium oxide (MgO) and barium oxide (BaO).

Specifically, at point A, a peak of the (111) plane as a specific crystal plane exists at a diffraction angle of 36.1 degrees between a diffraction angle of 36.9 degrees, which corresponds to the maximum diffraction angle for magnesium oxide (MgO) alone, and a diffraction angle of 32.2 degrees, which corresponds to the minimum diffraction angle for calcium oxide (CaO) alone. Similarly, at points B and C, peaks exist at 35.7 degrees and 35.4 degrees, respectively, between the maximum diffraction angle and the minimum diffraction angle.

Similarly to FIG. 3, FIG. 4 shows the results of X-ray diffraction in cases where metal oxide particles 93 are composed of three or more simple oxides. Specifically, in FIG. 4, point D indicates the result in a case where magnesium oxide (MgO), calcium oxide (CaO), and strontium oxide (SrO) are used as simple oxide components, point E indicates the result in a case where magnesium oxide (MgO), calcium oxide (CaO), and barium oxide (BaO) are used as simple oxide components, and point F indicates the result in a case where calcium oxide (CaO), strontium oxide (SrO), and barium oxide (BaO) are used as simple oxide components.

Specifically, at point D, a peak of the (111) plane as a specific crystal plane exists at a diffraction angle of 33.4 degrees between a diffraction angle of 36.9 degrees, which corresponds to the maximum diffraction angle for magnesium oxide (MgO) alone, and a diffraction angle of 30.0 degrees, which corresponds to the minimum diffraction angle for strontium oxide (SrO) alone. Similarly, at points E and F, peaks exist at 32.8 degrees and 30.2 degrees, respectively, between the maximum diffraction angle and the minimum diffraction angle.

In this embodiment, therefore, regardless of whether metal oxide particles 93 in PDP 1 according to this embodiment are composed of two or three simple oxides, X-ray diffraction analysis of the metal oxides, which form metal oxide particles 93, show a peak of a specific crystal plane at a diffraction angle between the minimum and maximum diffraction angles at which simple oxides as components of the metal oxides have peaks, respectively. Specifically, X-ray diffraction analysis of metal oxide particles 93 containing at least two metal oxides shows a diffraction peak of a specific crystal plane between a diffraction peak of the specific crystal plane of one of the two metal oxides and a diffraction peak of the specific crystal plane of another one of the two metal oxides.

While the above description has been given with respect to the (111) plane as a specific crystal plane, any other peak of any other crystal plane of the metal oxides will be located in the same manner as described above.

Calcium oxide (CaO), strontium oxide (SrO), and barium oxide (BaO) each have electrons in a region whose depth from the vacuum level is shallower than that of magnesium oxide (MgO). It is therefore conceivable that in the process of driving PDP 1, when electrons present at the energy level of calcium oxide (CaO), strontium oxide (SrO), or barium oxide (BaO) make transition to the ground state of xenon (Xe) ions, the number of electrons emitted by the Auger effect is larger than that in the case of the transition from the energy level of magnesium oxide (MgO).

In addition, as described above, metal oxide particles 93 in this embodiment has a peak at a diffraction angle between the minimum and maximum diffraction angles at which simple oxides as components of the metal oxides have peaks, respectively. The metal oxides having the characteristics shown in FIGS. 3 and 4 with respect to the results of X-ray diffraction analysis also have an energy level between those of simple oxide components thereof. It is therefore conceivable that metal oxide particles 93 also have an energy level between those of simple oxides and that the number of electrons emitted therefrom by the Auger effect is larger than that in the case of the transition from the energy level of magnesium oxide (MgO).

As a result, metal oxide particles 93 can deliver high secondary-electron emission performance as compared with magnesium oxide (MgO) alone, so that the discharge sustaining voltage can be reduced. Therefore, particularly when the partial pressure of xenon (Xe) in discharge gas is increased to increase brightness, discharge voltage can be reduced, so that a low-voltage and high-brightness PDP can be provided.

Table 1 shows the results of the discharge sustaining voltage of PDPs according to this embodiment, which are different in the composition of metal oxide particles 93 and in which mixed gas (15% Xe) of 450 Torr xenon (Xe) and neon (Ne) is sealed.

TABLE 1

| | | | | | | Comparative |
|---|---|---|---|---|---|---|
| | Sample A | Sample B | Sample C | Sample D | Sample E | Example |
| Discharge | 90 | 87 | 85 | 81 | 82 | 100 |
| sustaining | | | | | | |
| voltage | | | | | | |
| (arb. units) | | | | | | |

The discharge sustaining voltages shown in Table 1 are relative values when that of Comparative Example is normalized as 100. Table 1 shows the following cases. In sample A, metal oxide particles 93 are made of metal oxides: magnesium oxide (MgO) and calcium oxide (CaO). In sample B, metal oxide particles 93 are made of metal oxides: magnesium oxide (MgO) and strontium oxide (SrO). In sample C, metal oxide particles 93 are made of metal oxides: magnesium oxide (MgO) and barium oxide (BaO). In sample D, metal oxide particles 93 are made of metal oxides: magnesium oxide (MgO), calcium oxide (CaO), and strontium oxide (SrO). In sample E, metal oxide particles 93 are made of metal oxides: magnesium oxide (MgO), calcium oxide (CaO), and barium oxide (BaO). In Comparative Example, metal oxide particles 93 are made of magnesium oxide (MgO) alone.

When the partial pressure of xenon (Xe) in discharge gas increases from 10% to 15%, brightness increases by about 30%, but in Comparative Example where metal oxide particles 93 are made of magnesium oxide (MgO) alone, the discharge sustaining voltage increases by about 10%.

On the other hand, in all of samples A, B, C, D, and E, which correspond to the PDP according to this embodiment, the discharge sustaining voltage can be reduced by about 10% to 20% in contrast to Comparative Example. Therefore, the discharge starting voltage can be set within the normal operating range, so that a high-brightness, low-voltage-drivable PDP can be provided.

There has been a problem in which calcium oxide (CaO), strontium oxide (SrO), or barium oxide (BaO) alone has high reactivity and therefore reacts readily with impurities, so that electron emission performance can decrease. In this embodiment, however, the composition of the metal oxides reduces the reactivity and forms a crystal structure with less impurity contamination and less oxygen defects. Thus, excessive electron emission is suppressed during the driving of the PDP, and not only low-voltage driving and secondary electron emission performance are effectively achieved at the same time, but also an appropriate level of electron retention characteristics are effectively achieved. Such charge retention characteristics are particularly effective in retaining wall charges stored during the initialization period and achieving reliable writing discharge while preventing writing failure during the writing period.

Next, a detailed description is given of aggregate particles 92 each including a plurality of magnesium oxide (MgO) crystal particles 92a aggregated and deposited on base layer 91 in this embodiment. Aggregate particles 92 of magnesium oxide (MgO) have been found to be effective primarily in suppressing discharge delay at writing discharge and in reducing the temperature dependence of discharge delay. In this embodiment, therefore, aggregate particles 92 are provided as an initial electron supply component necessary at the discharge pulse rise time, based on the excellent initial electron emission characteristics of aggregate particles 92, which are higher than those of base layer 91.

It is conceivable that a major cause of discharge delay is that the amount of initial electrons serving as a trigger emitted from the surface of base layer 91 into discharge space 16 is insufficient. To contribute to the stable supply of initial electrons to discharge space 16, therefore, aggregate particles 92 of magnesium oxide (MgO) are scattered and deposited on the surface of base layer 91. This allows an abundant supply of electrons to discharge space 16 during the discharge pulse rise time, so that discharge delay can be avoided. Therefore, such initial electron emission characteristics enable high-speed driving with good discharge response even when PDP 1 is high-definition or the like. The feature that aggregate particles 92 of metal oxide are deposited on the surface of base layer 91 is effective primarily in suppressing discharge delay at writing discharge and also effective in reducing the temperature dependence of discharge delay.

In the embodiment described above, PDP 1 as base layer 91, which is effective in both reducing drive voltage and retaining charges, and aggregate particles 92 of magnesium oxide (MgO), which are effective in preventing discharge delay. In totality, therefore, PDP 1 can be driven at a high speed with a low voltage, even when it is a high-definition PDP, and can also deliver high-quality image display performance while suppressing lighting failure.

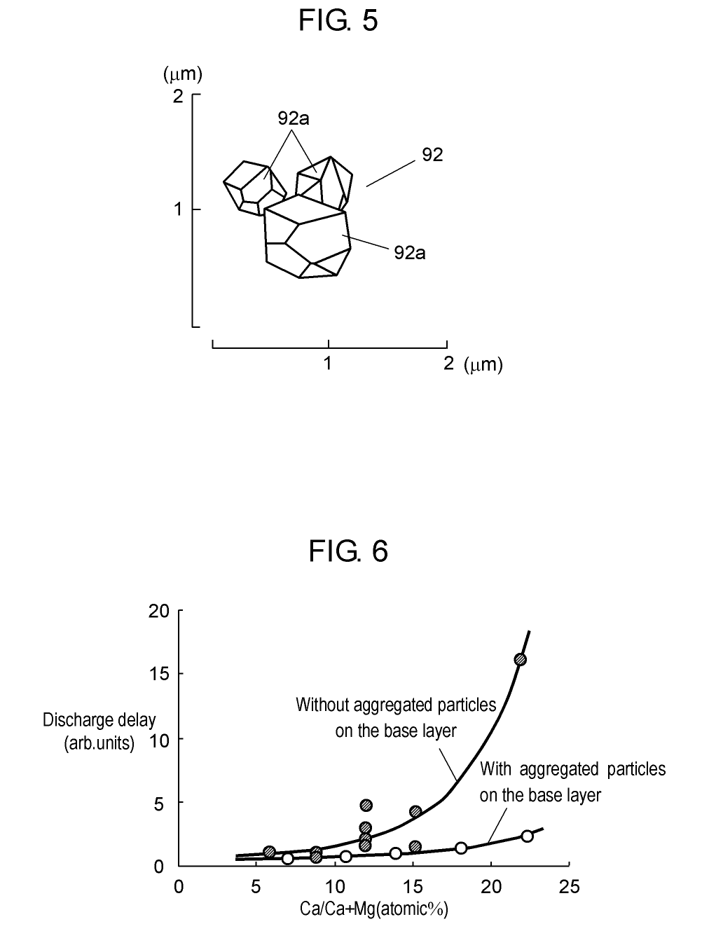

In this embodiment, aggregate particles 92 each including an aggregate of a plurality of crystal particles 92a are discretely scattered on base layer 91 in such a manner that a plurality of aggregate particles 92 are deposited and distributed substantially uniformly over the surface. FIG. 5 is an enlarged diagram for illustrating aggregate particle 92.

As shown in FIG. 5, aggregate particle 92 has crystal particles 92a with a specific primary particle diameter or diameters, which are aggregated or necked together. Specifically, a plurality of primary particles are not bonded with a large bonding force to form a solid, but formed into an aggregate by static electricity, Van der Waals force, or the like, in which the bonding is at such a level that the aggregate can be partially or entirely separated into primary particles by external stimulation such as ultrasonic waves. Aggregate particle 92 preferably has a particle diameter of about 1 μm, and crystal particles 92a preferably have a polyhedral shape having seven or more faces, such as a tetradecahedron or a dodecahedron.

The primary particle diameter of crystal particles 92a can be controlled by the crystal particle 92a -producing conditions. For example, when the particles are produced by firing an MgO precursor such as magnesium carbonate or magnesium hydroxide, the particle diameter can be controlled by controlling the firing temperature or the firing atmosphere. While the firing temperature may be generally selected in the range between 700° C. and 1,500° C., the particle diameter can be controlled to about 0.3 μm to about 2 μm by controlling the firing temperature to a relatively high temperature of 1,000° C. or more. In addition, when crystal particles 92a are obtained by heating an MgO precursor, primary particles are bonded through a phenomenon called aggregation or necking, so that aggregate particles 92 can be obtained.

FIG. 6 is a graph showing the relationship between the concentration of calcium (Ca) in the protective layer and discharge delay in the PDP according to this embodiment. Specifically, it shows the relationship between the concentration of calcium (Ca) in metal oxide particles 93 and discharge delay in a case where metal oxide particles 93 composed of magnesium oxide (MgO) and calcium oxide (CaO) as metal oxides are used in PDP 1. Metal oxide particles 93 are composed of metal oxides including magnesium oxide (MgO) and calcium oxide (CaO), and X-ray diffraction analysis of the metal oxides shows a peak at a diffraction angle between a diffraction angle at which magnesium oxide (MgO) has a peak and another diffraction angle at which calcium oxide (CaO) has a peak.

FIG. 6 shows a case where only metal oxide particles 93 are deposited on base layer 91 to form protective layer 9 and a case where metal oxide particles 93 and aggregate particles 92 are deposited on base layer 91, in which discharge delay is indicated with reference to the case where metal oxide particles 93 are not deposited on base layer 91.

FIG. 6 shows that in the case where aggregate particles 92 are not deposited on base layer 91, discharge delay increases with increasing concentration of calcium (Ca) in metal oxide particles 93, but in the case where aggregate particles 92 are deposited on base layer 91, discharge delay can be significantly reduced, and discharge delay hardly increases with increasing concentration of calcium (Ca) in metal oxide particles 93.

Next, a description is given of the results of an experiment which is performed to demonstrate the effect of protective layer 9 having aggregate particles 92 according to this embodiment. First, PDPs having base layers 91 different in composition and having aggregate particles 92 provided on base layer 91 are produced experimentally. Experimental product 1 is a PDP in which protective layer 9 is formed only of base layer 91 of magnesium oxide (MgO). Experimental product 2 is a PDP in which protective layer 9 is formed only of base layer 91 of magnesium oxide (MgO) doped with an impurity such as Al or Si. Experimental product 3 is a PDP in which protective layer 9 is formed by scattering and depositing only primary particles of magnesium oxide (MgO) as crystal particles 92a on base layer 91 of magnesium oxide (MgO).

On the other hand, experimental product 4 is PDP 1 according to this embodiment, in which sample A described above is used to form protective layer 9. Specifically, protective layer 9 includes base layer 91 made of magnesium oxide (MgO), aggregate particles 92 each including an aggregate of crystal particles 92a, and metal oxide particles 93 made of magnesium oxide (MgO) and calcium oxide (CaO), wherein aggregate particles 92 and metal oxide particles 93 are deposited and distributed substantially uniformly over base layer 91. X-ray diffraction analysis of metal oxide particles 93 shows a peak at a diffraction angle between the minimum and maximum diffraction angles at which simple oxides as components of metal oxide particles 93 have peaks, respectively. Specifically, in this case, the minimum and maximum diffraction angles are 32.2 degrees for calcium oxide (CaO) and 36.9 degrees for magnesium oxide (MgO), respectively, and metal oxide particles 93 have a peak at a diffraction angle of 36.1 degrees.

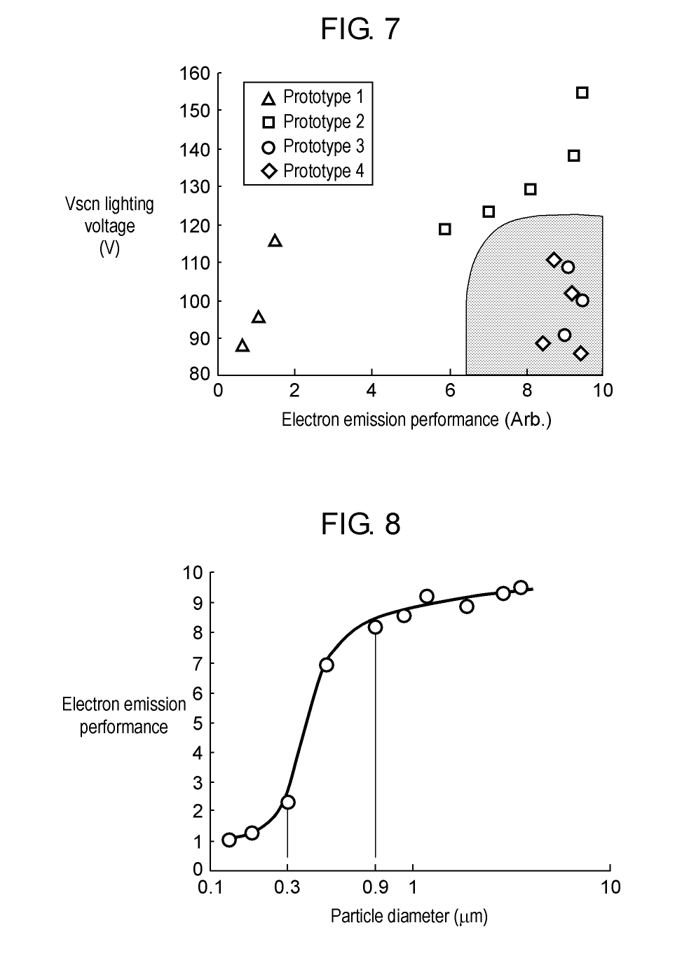

FIG. 7 shows the results of the examination of the electron emission performance and the charge retention performance of these PDPs. The electron emission performance is the value indicating that the higher the value, the larger the amount of electron emission, which is expressed by the amount of initial electron emission determined by the surface state, gas species, and the state thereof. The amount of initial electron emission can be determined by a method of measuring the amount of electron current emitted from the surface irradiated with ions or electron beams Unfortunately, there is some difficultly in making a non-destructive evaluation of the surface of front plate 2 of PDP 1. Therefore, the method described in Unexamined Japanese Patent Publication No. 2007-48733 is used. Specifically, among delay times during discharge, the value called statistical delay time, which is an index of easiness of discharge generation, is measured, and integration of the reciprocal of the value is performed to calculate a value linearly correlated with the amount of initial electron emission.

The evaluation is then performed using this value. The delay time during discharge means a discharge delay time by which discharge is delayed from the pulse rise, and a main cause of discharge delay is considered to be that when discharge is started, initial electrons serving as a trigger are not readily emitted from the surface of protective layer 9 into the discharge space.

The voltage applied in order to suppress the charge emission phenomenon in the prepared PDP (hereinafter, referred to as the lighting voltage Vscn) is used as an index of charge retention performance. The lower lighting voltage Vscn indicates the higher charge retention performance. In designing PDPs, this enables parts with a low withstand voltage and a low capacity to be used as power supply units or various electric parts. Semiconductor switching devices used in existing products, such as MOSFETs for sequentially applying a scan voltage to a panel, have a withstand voltage of about 150 V, and therefore, the lighting voltage Vscn is preferably kept at 120 V or less in view of temperature-induced fluctuations.

FIG. 7 is a chart showing the results of the study about the lighting voltage and the electron emission performance of the PDP according to this embodiment. FIG. 7 shows that experimental product 4, in which aggregate particles 92 each including an aggregate of magnesium oxide crystal particles 92a are scattered and distributed uniformly over base layer 91 according to this embodiment, successfully has a lighting voltage Vscn of 120 V or less in the evaluation of charge retention performance, and also offers electron emission performance significantly higher than that of experimental product 1 in which the productive layer is only made of magnesium oxide (MgO).

In general, a PDP has a trade-off between the electron emission performance and the charge retention performance of a productive layer. For example, electron emission performance can be increased by changing protective layer-forming conditions or doping a protective layer with an impurity such as Al, Si, or Ba, which, however, also produces an increase in lighting voltage Vscn as a side effect.

Experimental product 4, which corresponds to PDP 1 having protective layer 9 according to this embodiment, has electron emission performance at least 8 times higher than that of experimental product 1 in which protective layer 9 made only of magnesium oxide (MgO) is used, and also has a lighting voltage Vscn of at most 120 V for charge retention performance. Therefore, this embodiment is useful for a high-definition PDP with an increased number of scan lines and a reduced cell size and can provide both satisfactory electron emission performance and satisfactory charge retention performance, reduce discharge delay, and achieve satisfactory image display.

Next, a description is given of the particle diameter of magnesium oxide (MgO) crystal particles 92a used in protective layer 9 of PDP 1 according to this embodiment. In the description below, the term “particle diameter” means average particle diameter, and the term “average particle diameter” means volume-cumulative average diameter (D50).

FIG. 8 is a characteristic diagram showing the results of an experiment in which electron emission performance is examined using different particle diameters of crystal particles 92a in experimental product 4 according to this embodiment described above with reference to FIG. 7. In FIG. 8, the particle diameter of crystal particles 92a is measured by SEM observation of crystal particles 92a. FIG. 8 shows that when the particle diameter is reduced to about 0.3 μm, electron emission performance becomes low and that high electron emission performance is obtained with a particle diameter of about 0.9 μm or more.

On the other hand, the number of crystal particles 92a per unit area of base layer 91 is preferably as large as possible for the purpose of increasing the number of electrons emitted in the discharge cell, but it has been found that when crystal particles 92a are present on a part corresponding to the apex of barrier rib 14 of rear plate 10, which is in intimate contact with protective layer 9 of front plate 2, they can destroy the apex of barrier rib 14 and be placed on phosphor layer 15, so that a phenomenon can occur in which the corresponding cell cannot be normally turned on or off. This barrier rib-destroying phenomenon is less likely to occur when crystal particles 92a are absent on a part corresponding to the apex of barrier rib 14. Therefore, the possibility of occurrence of the destruction of barrier rib 14 increases with increasing number of deposited crystal particles 92a. From such a point of view, the possibility of barrier rib destruction increases abruptly when the crystal particle diameter increases to about 2.5 μm, and the possibility of barrier rib destruction can be kept relatively low when the crystal particle diameter is smaller than 2.5 μm.

From the above results, it has been found that in this embodiment, when aggregate particles 92 used in PDP 1 have a particle diameter in the range between 0.9 μm and 2 μm, the advantageous effects can be obtained constantly.

As described above, PDPs obtained according to this embodiment can have high electron emission performance and a lighting voltage Vscn of 120 V or less for charge retention performance.

While this embodiment has been described with respect to the case where magnesium oxide (MgO) particles are used as crystal particles 92a, other single crystal particles of metal oxide, such as Sr, Ca, Ba, or Al oxide crystal particles having high electron emission performance like magnesium oxide (MgO) may also be used to produce the same effect, and therefore, the particle species is not restricted to magnesium oxide (MgO).

### Second Exemplary Embodiment

Hereinafter, a description is given of a PDP according to a second exemplary embodiment of the present invention. The description of the same components as those in the first exemplary embodiment will be omitted.

While base layer 91 made of magnesium oxide (MgO) is used in the PDP according to the first exemplary embodiment, base layer 91 containing at least two metal oxides selected from the group consisting of magnesium oxide, calcium oxide, strontium oxide, and barium oxide is used in the PDP according to the second exemplary embodiment.

Next, a detailed description is given of protective layer 9 in this embodiment.

Protective layer 9 includes: base layer 91 formed on dielectric layer 8; aggregate particles 92 each including an aggregate of a plurality of magnesium oxide (MgO) crystal particles 92a deposited on base layer 91; and metal oxide particles 93 deposited on base layer 91. Base layer 91 and metal oxide particles 93 are made of metal oxides including at least two oxides selected from magnesium oxide (MgO), calcium oxide (CaO), strontium oxide (SrO), and barium oxide (BaO), and X-ray diffraction analysis of the metal oxides shows a peak of a specific crystal plane at a diffraction angle between the minimum and maximum diffraction angles each occurring for one oxide as a component of the metal oxides.

Specifically, X-ray diffraction analysis of metal oxide particles 93 containing at least two metal oxides shows a diffraction peak of a specific crystal plane between a diffraction peak of the specific crystal plane of one of the two metal oxides and a diffraction peak of the specific crystal plane of another one of the two metal oxides. In addition, X-ray diffraction analysis of base layer 91 containing at least two metal oxides shows a diffraction peak of a specific crystal plane between a diffraction peak of the specific crystal plane of one of the two metal oxides and a diffraction peak of the specific crystal plane of another one of the two metal oxides.

In this embodiment, the results of X-ray diffraction in the case where base layer 91 and metal oxide particles 93 are composed of two simple oxides are the same as the results of X-ray diffraction of metal oxide particles 93 shown in FIG. 3.

FIG. 3 also shows the results of X-ray diffraction analysis of magnesium oxide (MgO) alone, calcium oxide (CaO) alone, strontium oxide (SrO) alone, and barium oxide (BaO) alone.

In FIG. 3, the horizontal axis represents the Bragg's diffraction angle (2θ), and the vertical axis represents the X-ray diffraction wave intensity. The diffraction angle is expressed in units of degrees, wherein 360 degrees correspond to a full circle, and the intensity is expressed in arbitrary units. In FIG. 3, the crystal plane indicating a specific crystal orientation is parenthesized. FIG. 3 shows that for the (111) crystal plane, calcium oxide (CaO) alone has a peak at a diffraction angle of 32.2 degrees, magnesium oxide (MgO) alone at a diffraction angle of 36.9 degrees, strontium oxide (SrO) alone at a diffraction angle of 30.0 degrees, and barium oxide (BaO) alone at a diffraction angle of 27.9 degrees.

In PDP 1 according to this embodiment, base layer 91 and metal oxide particles 93 of protective layer 9 are made of metal oxides including at least two oxides selected from magnesium oxide (MgO), calcium oxide (CaO), strontium oxide (SrO), and barium oxide (BaO).

FIG. 3 shows the results of X-ray diffraction in cases where base layer 91 and metal oxide particles 93 are composed of two simple oxides. Specifically, point A indicates the result of X-ray diffraction of base layer 91 and metal oxide particles 93 formed using magnesium oxide (MgO) and calcium oxide (CaO), point B indicates the result of X-ray diffraction of base layer 91 and metal oxide particles 93 formed using magnesium oxide (MgO) and strontium oxide (SrO), and point C indicates the result of X-ray diffraction of base layer 91 and metal oxide particles 93 formed using magnesium oxide (MgO) and barium oxide (BaO).

Specifically, at point A, a peak of the (111) plane as a specific crystal plane exists at a diffraction angle of 36.1 degrees between a diffraction angle of 36.9 degrees, which corresponds to the maximum diffraction angle for magnesium oxide (MgO) alone, and a diffraction angle of 32.2 degrees, which corresponds to the minimum diffraction angle for calcium oxide (CaO) alone. Similarly, at points B and C, peaks exist at 35.7 degrees and 35.4 degrees, respectively, between the maximum diffraction angle and the minimum diffraction angle.

The results of X-ray diffraction in the case where base layer 91 and metal oxide particles 93 are composed of three or more simple oxides are the same as the results of X-ray diffraction in the case where metal oxide particles 93 are composed of three or more simple oxides, which are shown in FIG. 4. Specifically, in FIG. 4, point D indicates the result in a case where magnesium oxide (MgO), calcium oxide (CaO), and strontium oxide (SrO) are used as simple oxide components, point E indicates the result in a case where magnesium oxide (MgO), calcium oxide (CaO), and barium oxide (BaO) are used as simple oxide components, and point F indicates the result in a case where calcium oxide (CaO), strontium oxide (SrO), and barium oxide (BaO) are used as simple oxide components.

Specifically, at point D, a peak of the (111) plane as a specific crystal plane exists at a diffraction angle of 33.4 degrees between a diffraction angle of 36.9 degrees, which corresponds to the maximum diffraction angle for magnesium oxide (MgO) alone, and a diffraction angle of 30.0 degrees, which corresponds to the minimum diffraction angle for strontium oxide (SrO) alone. Similarly, at points E and F, peaks exist at 32.8 degrees and 30.2 degrees, respectively, between the maximum diffraction angle and the minimum diffraction angle.

In this embodiment, therefore, regardless of whether base layer 91 and metal oxide particles 93 in PDP 1 are composed of two or three simple oxides, X-ray diffraction analysis of the metal oxides, which form base layer 91 and metal oxide particles 93, show a peak of a specific crystal plane at a diffraction angle between the minimum and maximum diffraction angles at which simple oxides as components of the metal oxides have peaks, respectively.

Specifically, X-ray diffraction analysis of metal oxide particles 93 containing at least two metal oxides shows a diffraction peak of a specific crystal plane between a diffraction peak of the specific crystal plane of one of the two metal oxides and a diffraction peak of the specific crystal plane of another one of the two metal oxides. X-ray diffraction analysis of base layer 91 containing at least two metal oxides also shows a diffraction peak of a specific crystal plane between a diffraction peak of the specific crystal plane of one of the two metal oxides and a diffraction peak of the specific crystal plane of another one of the two metal oxides.

While the above description has been given with respect to the (111) plane as a specific crystal plane, any other peak of any other crystal plane of the metal oxides will be located in the same manner as described above.

Calcium oxide (CaO), strontium oxide (SrO), and barium oxide (BaO) each have electrons in a region whose depth from the vacuum level is shallower than that of magnesium oxide (MgO). It is therefore conceivable that in the process of driving PDP 1, when electrons present at the energy level of calcium oxide (CaO), strontium oxide (SrO), or barium oxide (BaO) make transition to the ground state of xenon (Xe) ions, the number of electrons emitted by the Auger effect is larger than that in the case of the transition from the energy level of magnesium oxide (MgO).

In addition, as described above, base layer 91 and metal oxide particles 93 in this embodiment have a peak at a diffraction angle between the minimum and maximum diffraction angles at which simple oxides as components of the metal oxides have peaks, respectively. The metal oxides having the characteristics shown in FIGS. 3 and 4 with respect to the results of X-ray diffraction analysis also have an energy level between those of simple oxide components thereof. It is therefore conceivable that base layer 91 and metal oxide particles 93 also have an energy level between those of simple oxides and that the number of electrons emitted therefrom by the Auger effect is larger than that in the case of the transition from the energy level of magnesium oxide (MgO).

As a result, base layer 91 and metal oxide particles 93 can deliver high secondary-electron emission performance as compared with magnesium oxide (MgO) alone, so that the discharge sustaining voltage can be reduced. Therefore, particularly when the partial pressure of xenon (Xe) in discharge gas is increased to increase brightness, discharge voltage can be reduced, so that a low-voltage and high-brightness PDP can be provided.

The results of the discharge sustaining voltage of PDPs according to this embodiment, which are different in the composition of base layer 91 and metal oxide particles 93 and in which mixed gas (15% Xe) of 450 Torr xenon (Xe) and neon (Ne) is sealed, are the same as those of PDPs which are different in the composition of metal oxide particles 93 as shown in Table 1.

The following cases are shown. In sample A, base layer 91 and metal oxide particles 93 are made of metal oxides: magnesium oxide (MgO) and calcium oxide (CaO). In sample B, base layer 91 and metal oxide particles 93 are made of metal oxides: magnesium oxide (MgO) and strontium oxide (SrO). In sample C, base layer 91 and metal oxide particles 93 are made of metal oxides: magnesium oxide (MgO) and barium oxide (BaO). In sample D, base layer 91 and metal oxide particles 93 are made of metal oxides: magnesium oxide (MgO), calcium oxide (CaO), and strontium oxide (SrO). In sample E, base layer 91 and metal oxide particles 93 are made of metal oxides: magnesium oxide (MgO), calcium oxide (CaO), and barium oxide (BaO). In Comparative Example, base layer 91 and metal oxide particles 93 are made of magnesium oxide (MgO) alone.

When the partial pressure of xenon (Xe) in discharge gas increases from 10% to 15%, brightness increases by about 30%, but in Comparative Example where base layer 91 and metal oxide particles 93 are made of magnesium oxide (MgO) alone, the discharge sustaining voltage increases by about 10%.

On the other hand, in all of samples A, B, C, D, and E, which correspond to the PDP according to this embodiment, the discharge sustaining voltage can be reduced by about 10% to 20% in contrast to Comparative Example. Therefore, the discharge starting voltage can be set within the normal operating range, so that a high-brightness, low-voltage-drivable PDP can be provided.

There has been a problem in which calcium oxide (CaO), strontium oxide (SrO), or barium oxide (BaO) alone has high reactivity and therefore reacts readily with impurities, so that electron emission performance can decrease. In this embodiment, however, the composition of the metal oxides reduces the reactivity and forms a crystal structure with less impurity contamination and less oxygen defects. Thus, excessive electron emission is suppressed during the driving of the PDP, and not only low-voltage driving and secondary electron emission performance are effectively achieved at the same time, but also an appropriate level of charge retention characteristics are effectively achieved. Such charge retention characteristics are particularly effective in retaining wall charges stored during the initialization period and achieving reliable writing discharge while preventing writing failure during the writing period.

In the examples shown at this time, base layer 91 and metal oxide particles 93 have the same composition. However, such examples are not intended to limit the embodiment, and even when base layer 91 and metal oxide particles 93 have different compositions, the same effect can be obtained.

Next, a detailed description is given of aggregate particles 92 each including an aggregate of a plurality of magnesium oxide (MgO) crystal particles 92a deposited on base layer 91 in this embodiment. Aggregate particles 92 of magnesium oxide (MgO) have been found to be effective primarily in suppressing discharge delay at writing discharge and in reducing the temperature dependence of discharge delay. In this embodiment, therefore, aggregate particles 92 are provided as an initial electron supply component necessary at the discharge pulse rise time, based on the excellent initial electron emission characteristics of aggregate particles 92, which are higher than those of base layer 91.

It is conceivable that a major cause of discharge delay is that the amount of initial electrons serving as a trigger emitted from the surface of base layer 91 into discharge space 16 is insufficient. To contribute to the stable supply of initial electrons to discharge space 16, therefore, aggregate particles 92 of magnesium oxide (MgO) are scattered and deposited on the surface of base layer 91. This allows an abundant supply of electrons to discharge space 16 during the discharge pulse rise time, so that discharge delay can be avoided. Therefore, such initial electron emission characteristics enable high-speed driving with good discharge response even when PDP 1 is high-definition or the like. The feature that aggregate particles 92 of metal oxide are deposited on the surface of base layer 91 is effective primarily in suppressing discharge delay at writing discharge and also effective in reducing the temperature dependence of discharge delay.

In the embodiment described above, PDP 1 has base layer 91, which is effective in both reducing drive voltage and retaining charges, and aggregate particles 92 of magnesium oxide (MgO), which are effective in preventing discharge delay. In totality, therefore, PDP 1 can be driven at a high speed with a low voltage, even when it is a high-definition PDP, and can also deliver high-quality image display performance while suppressing lighting failure.

In this embodiment, the relationship between the concentration of calcium (Ca) in protective layer 9 and discharge delay in the PDP produced using base layer 91 and metal oxide particles 93 containing magnesium oxide (MgO) and calcium oxide (CaO) is the same as the relationship shown in FIG. 6 between the concentration of calcium (Ca) in protective layer 9 and discharge delay in the PDP produced using base layer 91 and metal oxide particles 93 comprising magnesium oxide (MgO).

Base layer 91 and metal oxide particles 93 are composed of metal oxides including magnesium oxide (MgO) and calcium oxide (CaO), and X-ray diffraction analysis of the metal oxides shows a peak at a diffraction angle between a diffraction angle at which magnesium oxide (MgO) has a peak and another diffraction angle at which calcium oxide (CaO) has a peak.

FIG. 6 shows a case where protective layer 9 includes only base layer 91 and metal oxide particles 93 and a case where aggregate particles 92 and metal oxide particles 93 are deposited on base layer 91, in which discharge delay is indicated with reference to the case where base layer 91 is free of calcium (Ca).

FIG. 6 shows that in the case of only base layer 91 and metal oxide particles 93, discharge delay increases with increasing concentration of calcium (Ca), but in the case where aggregate particles 92 and metal oxide particles 93 are deposited on base layer 91, discharge delay can be significantly reduced, and discharge delay hardly increases with increasing concentration of calcium (Ca).

Next, a description is given of the results of an experiment which is performed to demonstrate the effect of protective layer 9 having aggregate particles 92 according to this embodiment. First, PDPs having base layers 91 different in composition and having aggregate particles 92 provided on base layer 91 are produced experimentally. Experimental product 1 is a PDP in which protective layer 9 is formed only of base layer 91 of magnesium oxide (MgO). Experimental product 2 is a PDP in which protective layer 9 is formed only of base layer 91 of magnesium oxide (MgO) doped with an impurity such as Al or Si. Experimental product 3 is a PDP in which protective layer 9 is formed by scattering and depositing only primary particles of magnesium oxide (MgO) as crystal particles 92a on base layer 91 of magnesium oxide (MgO).

On the other hand, experimental product 4 is PDP 1 according to this embodiment, in which sample A described above is used to form protective layer 9. Specifically, protective layer 9 includes base layer 91 composed of magnesium oxide (MgO) and calcium oxide (CaO), aggregate particles 92 each including an aggregate of crystal particles 92a, and metal oxide particles 93 composed of magnesium oxide (MgO) and calcium oxide (CaO), wherein aggregate particles 92 and metal oxide particles 93 are deposited and distributed substantially uniformly over base layer 91. X-ray diffraction analysis of base layer 91 and metal oxide particles 93 shows a peak at a diffraction angle between the minimum and maximum diffraction angles at which simple oxides as components of base layer 91 and metal oxide particles 93 have peaks, respectively. Specifically, in this case, the minimum and maximum diffraction angles are 32.2 degrees for calcium oxide (CaO) and 36.9 degrees for magnesium oxide (MgO), respectively, and base layer 91 and metal oxide particles 93 have a peak at a diffraction angle of 36.1 degrees.

The results of the examination of the electron emission performance and the charge retention performance of these PDPs are similar to those in the first exemplary embodiment, which are shown in FIG. 7.

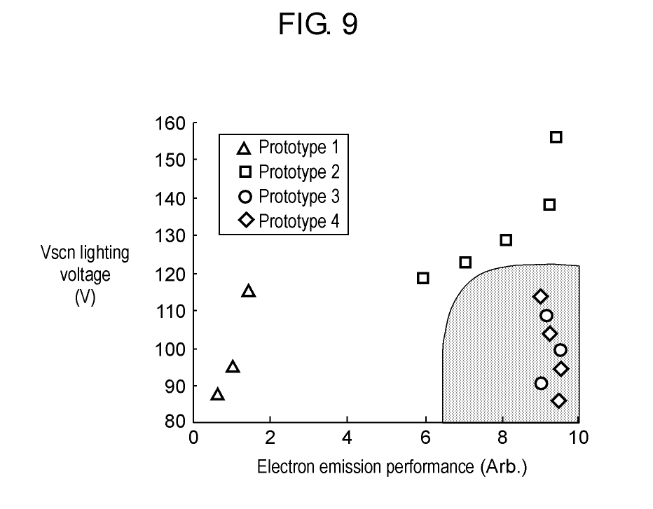

FIG. 9 is a chart showing the results of the study about the lighting voltage and the electron emission performance of the PDP according to this embodiment. FIG. 9 shows that experimental product 4, in which aggregate particles 92 each including an aggregate of magnesium oxide (MgO) crystal particles 92a are scattered and distributed uniformly over base layer 91 according to this embodiment, successfully has a lighting voltage Vscn of 120 V or less in the evaluation of charge retention performance, and also offers electron emission performance significantly higher than that of experimental product 1 in which the productive layer is only made of magnesium oxide (MgO).

Experimental product 4, which corresponds to PDP 1 having protective layer 9 according to this embodiment, has electron emission performance at least 8 times higher than that of experimental product 1 in which protective layer 9 made only of magnesium oxide (MgO) is used, and also has a lighting voltage Vscn of at most 120 V for charge retention performance. Therefore, this embodiment is useful for a high-definition PDP with an increased number of scanning lines and a reduced cell size and can provide both satisfactory electron emission performance and satisfactory charge retention performance, reduce discharge delay, and achieve satisfactory image display.

A characteristic diagram showing the results of an experiment in which electron emission performance is examined using different particle diameters of crystal particles 92a in experimental product 4 according to this embodiment is the same as the characteristic diagram of FIG. 8 showing the results of an experiment in which electron emission performance is examined using different particle diameters of crystal particles 92a in experimental product 4 according to the first exemplary embodiment.

From the above results, it has been found that in this embodiment, when aggregate particles 92 used in PDP 1 have a particle diameter in the range between 0.9 μm and 2 μm, the advantageous effects can be obtained constantly.

As described above, PDPs obtained according to this embodiment can have high electron emission performance and a lighting voltage Vscn of 120 V or less for charge retention performance.

While this embodiment has been described with respect to the case where magnesium oxide (MgO) particles are used as crystal particles 92a, other single crystal particles of metal oxide, such as Sr, Ca, Ba, or Al oxide crystal particles having high electron emission performance like magnesium oxide (MgO) may also be used to produce the same effect, and therefore, the particle species is not restricted to magnesium oxide (MgO).

### INDUSTRIAL APPLICABILITY

As described above, the present invention is useful for providing PDPs with high-quality image display performance and low power consumption.

### REFERENCE MARKS IN THE DRAWINGS

1 PDP

2 Front plate

3 Front glass substrate

4 Scan electrode

4a, 5a Transparent electrode

4b, 5b Metal bus electrode

5 Sustain electrode

6 Display electrode

7 Black stripe (light-shielding layer)

8 Dielectric layer

9 Protective layer

10 Rear plate

11 Rear glass substrate

12 Address electrode

13 Insulating layer

14 Barrier rib

15 Phosphor layer

16 Discharge space

81 First dielectric layer

82 Second dielectric layer

91 Base layer

92 Aggregate particle

92a Crystal particle

93 Metal oxide particle

1. A plasma display panel comprising a front plate and a rear plate opposed to the front plate,
the front plate having a dielectric layer and a protective layer placed over the dielectric layer,
the rear plate having an insulating layer, a plurality of barrier ribs formed on the insulating layer, and phosphor layers formed on the insulating layer and sides of the barrier ribs,
the protective layer including a base layer formed on the dielectric layer,
the base layer having aggregate particles and metal oxide particles scattered thereon for covering an entire face of the base layer, each of the aggregate particles including an aggregate of a plurality of magnesium oxide crystal particles,
wherein the metal oxide particles contains at least two metal oxides selected from a group consisting of magnesium oxide, calcium oxide, strontium oxide, and barium oxide,
X-ray diffraction analysis of the metal oxide particles shows a diffraction peak of a specific crystal plane between a diffraction peak of the specific crystal plane of one of the two metal oxides and a diffraction peak of the specific crystal plane of another one of the two metal oxides.

2. The plasma display panel according to claim 1, wherein the metal oxide particles are deposited at a coverage between 5% and 50%.

3. The plasma display panel according to claim 1, wherein the metal oxide particles are deposited at a coverage between 5% to 25%.
